(19) United States
(12) Patent Application Publication
(10) Pub. No.: US 2012/0185842 A1
(43) Pub. Date: Jul. 19, 2012

(54) SYSTEM AND METHOD FOR PROVIDING AN APPLICATION INSTALLATION TOOL

(75) Inventors: Chakradhar Sriperumbudur, Wesley Chapel, FL (US); Robert P. Kilgore, Carrbelle, FL (US); Ovid Lane Hunt, Salsbury Mills, NY (US); Mary Senica, Cedar Rapids, IA (US)

(73) Assignee: VERIZON PATENT AND LICENSING INC., Basking Ridge, NJ (US)

(21) Appl. No.: 13/006,910

(22) Filed: Jan. 14, 2011

(51) Int. Cl. G06F 9/445

(52) U.S. Cl. 717/174

(57) ABSTRACT

A system and method for providing an application installation tool is disclosed. The system may comprise an input module configured to receive an identifier of a new computing device and at least one user-selected application from a list of user-selectable applications for installation at the new computing device. The system may also comprise an output module configured to output at a display device the list of user-selectable applications for user selection based on the identifier of the new computing device. The system may also comprise a processor module configured to install the at least one user-selected application to the new computing device based on the identifier and the user selection, wherein the processor module is communicatively coupled to at least one applications database from which the at least user-selected application is distributed.

### BACKGROUND INFORMATION

A number of systems management technologies have been developed to unify and facilitate management of distributed computing environments. Some key features of systems management technologies include remote management of applications, management of several instances of an application, remote application interfacing across difference platforms, and application management decoupling. Typically, when a user receives a new or replacement computing device, traditional systems management technologies generally allow an administrator to install a base image and then reinstall relevant applications. However, this process is time-consuming and requires new requests for licensed applications. Current system management technologies do not provide a comprehensive and efficient way to provide an application installation tool to facilitate installation or reinstallation of licensed applications in a new or replacement computing device.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system architecture for providing an application installation tool, according to an exemplary embodiment.

FIG. 2 depicts a hardware module component of a system for providing an application installation tool, according to an exemplary embodiment.

FIG. 3 depicts an illustrative flow for providing an application installation tool, according to an exemplary embodiment.

FIG. 4A depicts an illustrative screen for providing an application installation tool, according to an exemplary embodiment.

FIG. 4B depicts an illustrative screen for providing an application installation tool, according to an exemplary embodiment.

FIG. 4C depicts an illustrative screen for providing an application installation tool, according to an exemplary embodiment.

FIG. 4D depicts an illustrative screen for providing an application installation tool, according to an exemplary embodiment.

FIG. 5 depicts an illustrative flow for providing an application installation tool, according to another exemplary embodiment.

FIG. 6 depicts an illustrative flow for providing a web service component of an application installation tool, according to an exemplary embodiment.

FIG. 7 depicts an illustrative flowchart of a method for using an application installation tool, according to an exemplary embodiment.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. It should be appreciated that the following detailed description are exemplary and explanatory only and are not restrictive.

Exemplary embodiments may provide a system and method for providing an application installation tool. That is, exemplary embodiments may, among other things, expand and optimize systems management within distributed computing environments by comprehensively and effectively providing an application installation tool to facilitate installation or reinstallation of licensed applications in a new or replacement computing device.

As discussed above, systems management technologies are useful for unifying and facilitating management of distributed computing environments. These systems management technologies are generally capable of remote management of applications, management of several instances of an application, remote application interfacing across difference platforms, and application management decoupling. Typically, when a user receives a new or replacement computing device, traditional systems management technologies generally allow an administrator to install a base image and then reinstall relevant applications. However, this process is time-consuming and requires new requests for licensed applications. Using an application installation tool according to various embodiments, a comprehensive and efficient way to facilitate installation or reinstallation of licensed applications in a new or replacement computing device may be provided.

For example, a large company may have 200,000 employees and each employee may have at least one computing device. The company may have an ongoing process of upgrading hardware, where old computing devices may be replaced with new computing devices. Traditionally, all old computing devices that needed to be replaced would be collected, a new replacement computing device would then be assigned to each user who had their old computing devices collected, and then all the requisite software applications would be installed in each of the new replacement computing device for each specific user before these computing devices are redistributed to users. Some applications that needed to be installed in the new replacement computing devices may be new applications that never existed in the old computing devices. However, a majority of applications that needed to be installed may be old or existing applications that resided in the old computing device. The traditional way of installing these applications may be extremely resource-intensive. For example, not only would these applications need to be installed physically onto each new or replacement computing device, licenses for the old applications may need to be re-requested when each application is reinstalled on the new or replacement computing devices. The traditional process may also be extremely time-consuming. For example, replacement of each computing device may take several days using the traditional method and the company's work production may be affected by employees not having their computing devices at hand. While some companies may be equipped to provide employees with temporary computing devices, reduced production may still result due to such a hardware replacement process.

According to various embodiments, an application installation tool may provide a streamlined approach for installing or reinstalling applications from an old computing device onto a new or replacement computing device that is comprehensive, efficient, and resource savvy. An application installation tool may therefore eliminate, mitigate, or preempt traditional inefficiencies associated with such traditional techniques.

It should be appreciated that the term, “application,” as used herein, may refer to any data that is installed or moved onto a computing device. Such data may include a file or a plurality of files, an application suite, as well as all associated settings, registry keys, metadata, etc. In some embodiments, an application may also include any peripheral hardware that is associated with such data. Although embodiments of the present disclosure are primarily discussed with respect to installing or moving applications in one or more computing devices, it should be appreciated that other types of data may installed, reinstalled, moved, etc. using the application installation tool. [Please confirm definition.]

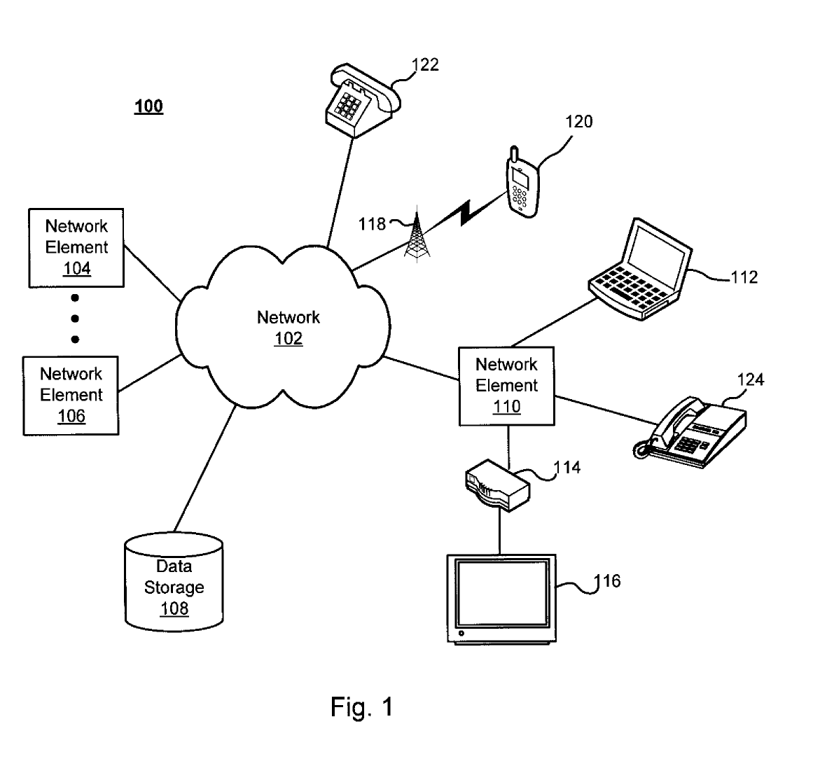

FIG. 1 depicts a block diagram of a system architecture for providing an application installation tool, according to an exemplary embodiment. As illustrated, network 102 may be communicatively coupled with one or more devices including network element 104, network element 106, data storage 108, and network element 110. Other devices may be communicatively coupled with network 102 via one or more intermediary devices, such as transceiver 118, network element 110, or a wireline phone 122. Wireless device 120 may be communicatively coupled with network 102 via transceiver 118. Network client 112 and set-top box 114 may be communicatively coupled with network 102 via network element 110. Wireless control 110 may be communicatively coupled with set-top box 114 via infrared, Bluetooth communication, or other wireless technologies. A video display (e.g., television set 116) may be communicatively coupled to set-top box 114. It should also be appreciated that other various components may also be communicatively coupled with the network element 110, such as a Voice over Internet Protocol (“VoIP”) phone 124.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11h, 802.15.1, 802.11n and 802.11g or any other wired or wireless network for transmitting or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support, an Internet network, a wireless communication network, a cellular network, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a broadcaster's network, a cable television network, corporate networks, or home networks.

Network elements 104, 106, 110, and data storage 108 may transmit and receive data to and from network 102 representing broadcast content, user request content, mobile communications data, or other data. The data may be transmitted and received utilizing a standard telecommunications protocol or a standard networking protocol. For example, one embodiment may utilize Session Initiation Protocol (“SIP”). In other embodiments, the data may be transmitted or received utilizing other Voice Over IP (“VOIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 may use standard wireless protocols including IEEE 802.11a, 802.11b and 802.11g. Network 102 may also use protocols for a wired connection, such as an IEEE Ethernet 802.3.

Transceiver 118 may be a repeater, a microwave antenna, a cellular tower, or another network access device capable of providing connectivity between to different network mediums. Transceiver 118 may be capable of sending or receiving signals via a mobile network, a paging network, a cellular network, a satellite network or a radio network. Transceiver 118 may provide connectivity to one or more wired networks and may be capable of receiving signals on one medium such as a wired network and transmitting the received signals on a second medium, such as a wireless network.

Wireless device 120 may be a mobile communications device, wireline phone, a cellular phone, a mobile phone, a satellite phone, a personal digital assistant (“PDA”), a computer, a handheld MP3 player, a handheld multimedia device, a personal media player, a gaming device, or other devices capable of communicating with network 102 via transceiver 118.

Network elements, transceiver 118, data storage 108, and set-top box 114 may include one or more processors for recording, transmitting, receiving, or storing data. Although network elements, transceiver 118 and data storage 108 are depicted as individual elements, it should be appreciated that the contents of one or more of a network element, transceiver 118, and data storage 108 may be combined into fewer or greater numbers of devices and may be connected to additional devices not depicted in FIG. 1. Furthermore, the one or more devices may be local, remote, or a combination thereof a first network elements, transceiver 118, and data storage 108.

Data storage 108 may be network accessible storage and may be local, remote, or a combination thereof to network elements 104, 106, and 110. Data storage 108 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, Data storage 108 may be a database, such as an Oracle database, a Microsoft SQL Server database, a DB2 database, a MySQL database, a Sybase database, an object oriented database, a hierarchical database, or other database. Data storage 108 may utilize flat file structures for storage of data.

Network elements 104, 106, and 110 may be one or more servers (or server-like devices), such as a Session Initiation Protocol (“SIP”) server. Network elements 104, 106, and 110 may include one or more processors (not shown) for recording, transmitting, receiving, or storing data. According to one or more embodiments, network elements 104, 106, and 110 may be servers providing media content to one or more users. In other embodiments, network elements 104, 106, and 110 may be servers that provide network connection between two or more wireless devices 118. Network elements 104, 106, and 110 may also be servers of a service provider, the Internet, a broadcaster, a cable television network, or another media provider.

Network element 110 may be a residential gateway, such as a router, an optical network terminal or another piece of Customer Premises Equipment (“CPE”) providing access to one or more pieces of equipment. For example, network element 110 may provide audio/video programming content feeds to a set-top box, such as set-top box 116. Network element 110 may also provide network connectivity for other clients, such as a Voice Over IP (“VOIP”) phone (not shown) and a network client, e.g., network client 112.

Network client 112 may be a desktop computer, a laptop computer, a server, a personal digital assistant, or other computer capable of sending or receiving network signals (e.g., CPE, a television, radio, phone, appliance, etc.). Network client 112 may use a wired or wireless connection. It should also be appreciated that the network client 112 may be a portable electronic device capable of being transported. For example, these may include a digital picture frame, an electronic reader device, or other portable device. Such a device may transmit or receive signals and store information in transit, and in the event it is transported out of the unit, the portable electronic device may still operate using the data (e.g., digital image, electronic book, etc.) it stored. Although depicted as connected via a residential gateway in FIG. 1, it should be appreciated that the network client 112 may connect directly to network 102 or via other network connectivity devices as well. According to one or more embodiments, network client 112 using a wireless connection may authenticate with a network using Wired Equivalent Privacy (“WEP”), Wi-Fi Protected Access (“WPA”), or other wireless network security standards.

System 100 may be used for mobile telecommunications between two or more components of the system 100, e.g., two or more wireless devices, wireless device with network client, set top box with wireless device, landline phone, VoIP, etc. System 100 may also be used for transmitting or receiving a variety of content. The various components of system 100 as shown in FIG. 1 may be further duplicated, combined or integrated to support various applications and platforms. Additional elements may also be implemented in the systems described above to support various applications. It should be appreciated that the term, “computing device,” as used herein, may refer to any component associated with system 100, as described above. These may include, but are not limited to, vendor-side components 104-108, subscriber-side components 110-124, or any other device communicatively coupled to network 102 or association with system 100.

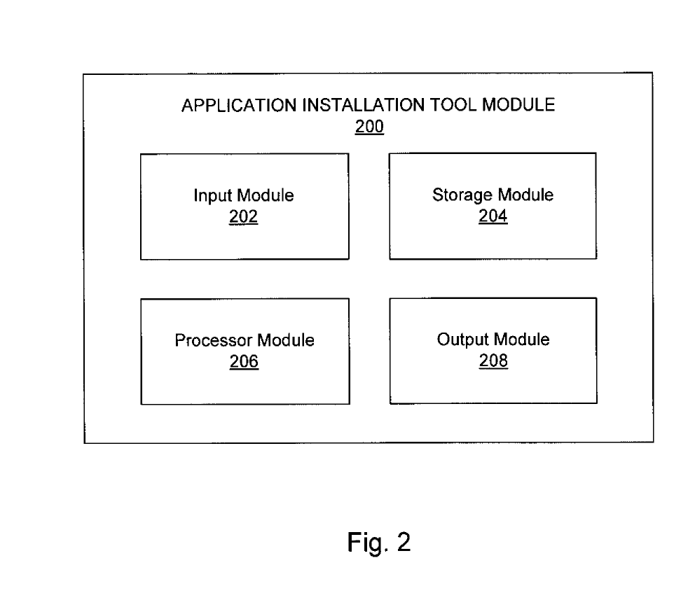

FIG. 2 depicts a hardware module component of a system for providing an application installation tool, according to an exemplary embodiment. Referring to FIG. 2, there is shown an application installation module 200 for providing an application installation tool. As illustrated, the application installation module 200 may comprise one or more components, such as an input module 202, a storage module 204, a processor module 206, and an output module 208. Although the application installation module 200 is depicted as a single module, the application installation module 200 may be incorporated as a single component or may be distributed across a plurality of physical components, such as one or more centralized servers, pieces of customer premises equipment, or end user devices. In some embodiments, the application installation module 200 may be utilized in a virtual environment or as software.

Input module 202 may receive one or more inputs. These may include input information identifying one or more computing devices or what data (e.g., applications) to be installed in the one or more computing devices. Storage module 204 may manage or access the one or more inputs using electronic storage, including databases or other organized electronic storage. Storage module 204 may provide one or more interfaces for the input module 202, processor module 206, or output module 208. Storage module 204 may store any data associated with the input module 202, processor module 206, and output module 208. Storage module 204 may be or may be communicatively coupled to one or more physical media, such as but not limited to, a data storage unit, a server, a compact disc (CD), a digital versatile disc (DVD), a floppy disk, a hard drive, read only memory (ROM), random access memory (RAM), as well as other physical media capable of storing software, data, other storage information, or combinations thereof.

Processor module 206 may process the data. For example, processor module 206 may delete data (e.g., an application) from an old computing device and install the data (e.g., application) in a new replacement computing device based on information from the input module 202 and/or the storage module 204. Output module 208 may present a variety of information for presented. For example, the output module 208 may output the list of applications that may be installed in the new replacement computing device for user selection. The output module 208 may also output one or more reports associated with the installation, e.g., a report summary of the installation update of the old or new computing device.

It should be appreciated that the system 100 of FIG. 1 and the system 200 of FIG. 2 may be implemented in a variety of ways. The architectures 100 and 200 may be implemented as a hardware component (e.g., as a module) within a network element or network box. It should also be appreciated that the architectures 100 and 200 may be implemented in computer executable software (e.g., on a computer-readable medium). Although depicted as a single architecture, module functionality of the architectures 100 and 200 may be located on a single device or distributed across a plurality of devices including one or more centralized servers and one or more pieces of customer premises equipment or end user devices.

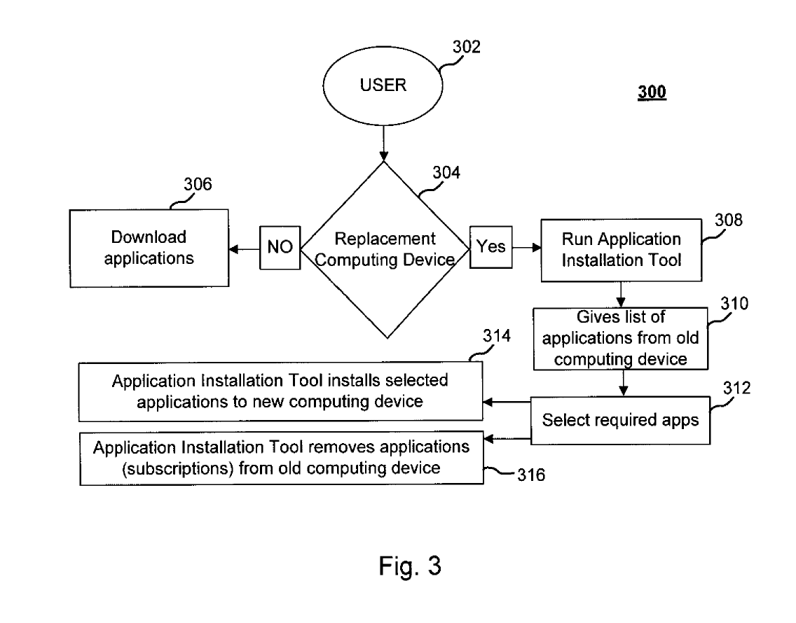

FIG. 3 depicts an illustrative flow for providing an application installation tool 300, according to an exemplary embodiment. In this example, a user 302 may determine whether a computing device requires replacement 304. If replacement is not necessary, the user may update or install one or more application via download 306. This may be achieved by accessing a central database of applications, such as data storage 108. If it is determined that replacement of the computing device is necessary by the user, an application installation tool may be used 308 to install or reinstall applications of the old computing device to a new replacement computing device.

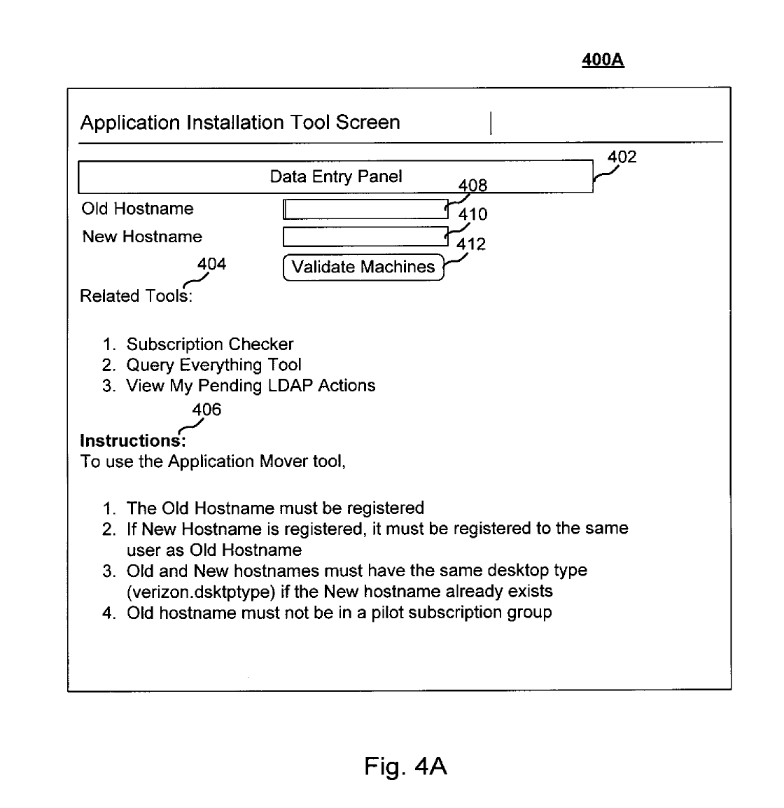

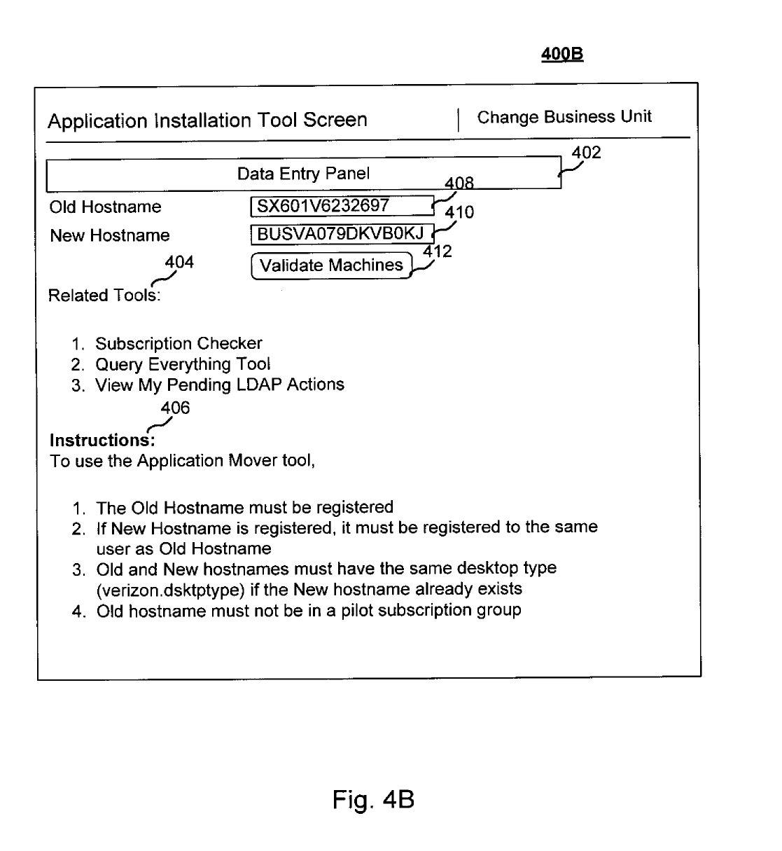

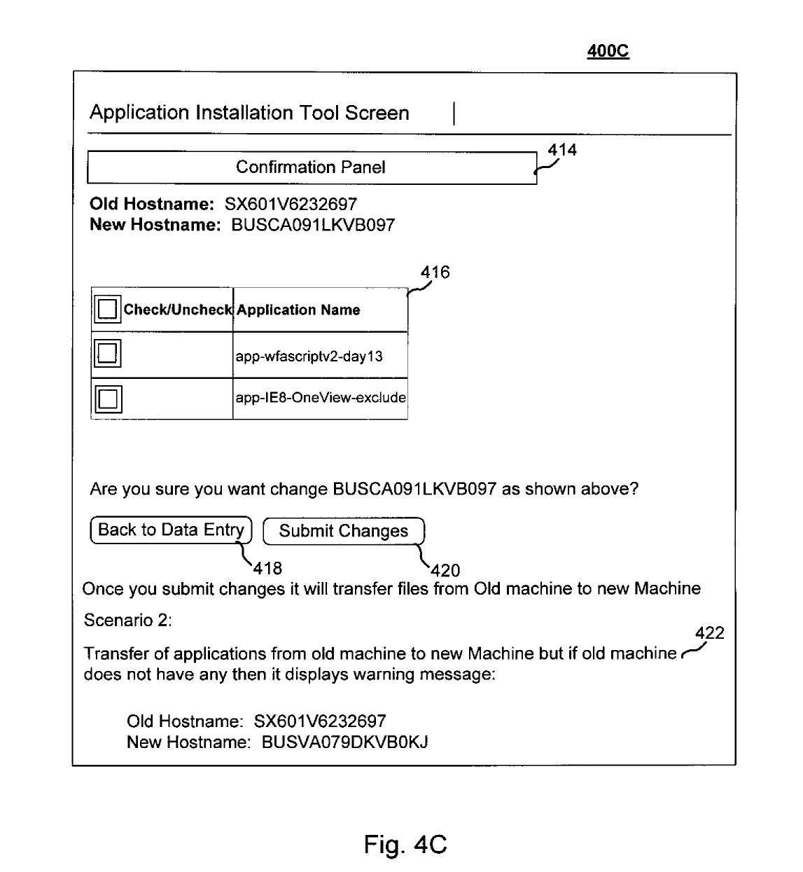

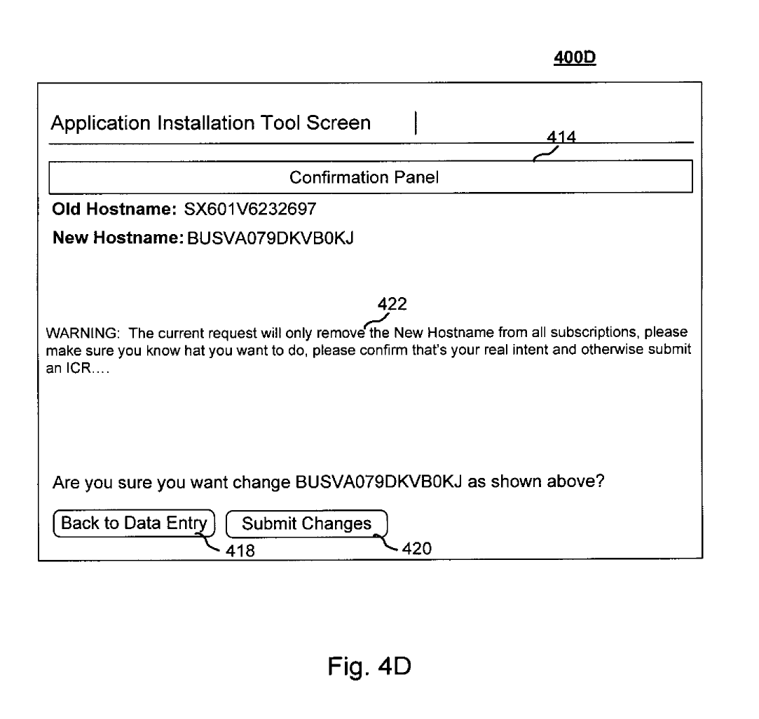

FIG. 4A depicts an illustrative screen for providing an application installation tool 400A, according to an exemplary embodiment. As described above, when a user 302 determines that an old computing device needs to be replaced with a new replacement computing device, the user 302 may run an application installation tool 308 via the application installation tool module 200 of FIG. 2. The application installation tool screen 400A may provide various sections. These may include a data entry area 402, a related tools area 404, and instructions on how to use the application installation tool screen or other information area 406.

The data entry area 402 may have an area or form field to enter an Old Hostname 408 and a New Hostname 410. The Old Hostname 408 may be an identifier of the old computing device and the New Hostname 410 may be an identifier of the new replacement computing device.

The related tools area 404 may provide a list of tools or actions that the user may be able to perform related to the task at hand. For example, these may include a subscription checker, query everything tool, viewing various pending actions, and a variety of the related functions and actions useful to the user 302.

The instructions or other information area 406 may specifically inform the user 302 what is required in the form fields. For example, the Old Hostname and New Hostname “must be registered” before they are entered into form fields 408 and 410 of the application installation tool screen 400A. Other various instructions may also be provided to aid the user in using the application installation tool. Although not depicted, a variety of other options may be available to the user in the application installation tool screen 400A. These may include hyperlinks, references, features, or functions that may aid the user 302 in completing the installation of applications onto the new replacement computing device.

FIG. 4B depicts an illustrative data entry screen for providing an application installation tool 400B, according to an exemplary embodiment. In this example, the user 302 has entered a registered Old Hostname (e.g., “SX01V6232697”) and a registered New Hostname (e.g., “BUSVA079DKVB0KJ”). Once the Old and New Hostnames are entered, the user 302 may select the “Validate Machines” button or hyperlink to confirm the entries.

Referring back to FIG. 3, the flow 300 may then provide a list of applications 310 for a user to choose from, such as those from the old computing device, to install onto the new replacement computing device associated with the New Hostname.

FIG. 4C depicts an illustrative confirmation screen for providing an application installation tool 400C, according to an exemplary embodiment. In this example, the entered or selected Old Hostname and New Hostname may be presented in a confirmation panel section 414 of the screen so the user may confirm correct entry of the identifiers. The confirmation screen 400C may also present an application selection area 416, which may present one or more applications for the user to install on to the new replacement computing device associated with the New Hostname entered by the user 302. In some embodiments, the list of one or more applications may be applications that were originally installed on the old computing device associated with the Old Hostname entered by the user 302. Although check boxes are depicted for users to select the one or more applications, other various selection features may be provided, such as radio buttons, hyperlinks, open form fields, etc. A search tool may also be provided to assisting in finding the one or more applications to install.

It should be appreciated that a user 302 may not be limited to installing only those applications installed on the old computing device. For example, the user 302 may have access to all applications that may or may not have been installed on the old computing device. These may include applications available for the user 302 if the computing device was determined to not be replaced, as described above with respect to FIG. 3. In some embodiments, a list of these one or more applications may be also provided in the confirmation screen 400C.

It should be appreciated that the confirmation screen 400C may provide other related features and functions. For example, in addition to installing applications not previously installed in the old computing device, a user may be able to schedule when to install each application onto the new replacement computing device. An installation scheduling area (not shown) may be provided on the confirmation screen 400C where the user 302 may choose a date/time or other scheduling-related information to install the one or more selected applications onto the new replacement computing device. By providing such a scheduling feature, installation of the software onto the new replacement computing device may provide flexibility and maximize system resources. For instance, if several users are planning to install a large quantity of applications for several new replacement computing devices all around the same time during peak hours, network and system resources may not be readily available for such a large action. Thus, a scheduling feature enables an additional layer of efficiency.

It should also be appreciated that the scheduling may be automatic or a combination of manual and automatic. In an automatic embodiment, the application installation tool module 200 may automatically determine the best date/time to install the one or more applications onto the new replacement computing device. The application installation tool module 200 may determine such date/time based on a variety of factors, such as network/system availability, queue of other action items, when a new replacement computing device is needed, etc. In a manual-automatic embodiment, the user 302 may enter a date or time range and the application installation tool module 200 may automatically determine the exact date/time for application installation. Other various embodiments may also be provided to maximize network resources, minimize installation or replacement time, and improve overall efficiency.

Once the options are determined or selected, the confirmation screen 400C may allow the user 302 to edit information using a “Back to Data Entry” button or hyperlink 418. If there are no changes, the user may proceed to the next screen by using the “Submit Changes” button or hyperlink 420. It should also be appreciated that the confirmation screen 400C may also provide other options, such as an information or instructions area 422 to inform the user 302 of available options.

FIG. 4D depicts an illustrative confirmation screen for providing an application installation tool 400D, according to another exemplary embodiment. Similar to confirmation screen 400C of FIG. 4C, the confirmation screen 400D of FIG. 4D also comprises a confirmation panel area 414 and an instructions or information area 422. However, in this example, rather than presenting all the various options and features, as depicted in FIG. 4C, the confirmation screen 400D of FIG. 4D may be simplified to allow a user 302 the ability to easily confirm the Old Hostname and the New Hostname. To make changes, the user 302 may select the “Back to Data Entry” button or hyperlink 418. If there are no changes, the user may proceed and select the “Submit Changes” button or hyperlink 410, and the application installation tool module 200 may begin application installation onto the new replacement computing device corresponding to the New Hostname. The instructions and information area 422 may include a warning message informing the user 302 what will happen once the “Submit Changes” button or hyperlink 410 is selected or some other potential issue. A simplified confirmation screen 400D may provide an easier way for installing applications of an old computing device onto a new replacement device without the hassle of determining other options and feature to include, which may be determined at a later time or by another user or department. In otherwise, the simplified confirmation screen 400D provides a more streamlined approach for configuring and installing applications on a new replacement computing device.

Referring back to FIG. 3, once all the desired applications are selected and confirmed to be installed 312, the application installation tool module 200 may install applications of the old computing device onto the new replacement computing device 314. The application installation module 200 may also remove all application (subscriptions) from the old computing device 316.

While embodiments described above are primarily directed to installing applications on a new replacement computing device, it should be appreciated that the application installation tool module 200 may also be used for non-replacement computing device. For example, if a company plans to have various levels of computer users (e.g., administrators, developers, users, etc.), the application installation tool module 200 may be used to create a template for any one of these levels, which may use all the same applications. In other words, the application installation tool module 200 may be used, not only to reinstall applications from an old computing device to a replacement computing device, to install applications onto a new non-replacement computing device for the first time to a specific type of user. By using the application installation tool module 200 to create a template for a specific type of user (e.g., developer), all new computing devices set to be delivered to these users may be easily and efficiently configured to have the same applications installed on their computing devices.

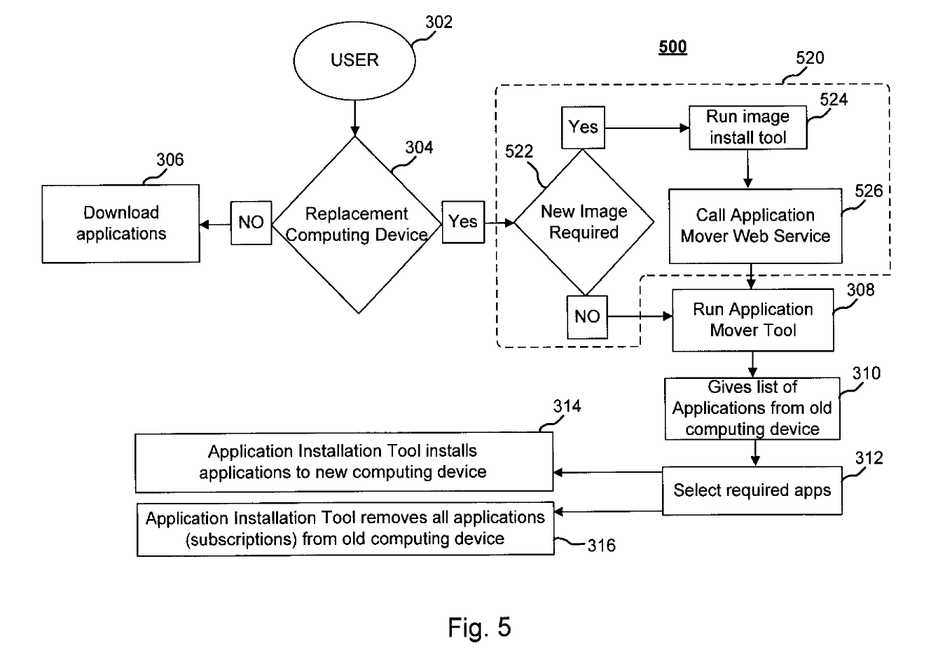

FIG. 5 depicts an illustrative flow for providing an application installation tool 500, according to another exemplary embodiment. Flow 500 is similar to flow 300 of FIG. 3, however, in the event a new image (e.g. of an operating system) is required for the new replacement computing device, flow 500 provides an image installation component of the application installation tool 520 to acquire a new image before installing applications.

Once it is determined that a new replacement computing device is needed to replace and old computing device, the image installation component 520 may inquire whether a new image is required for the new replacement computing device 522. If not, flow 500 may proceed to run the application installation tool 300, similar to that of flow 300 of FIG. 3. However, if a new image is required, an image of the operating system, for example, may be installed using an image installation tool 524. Once the image installation tool 524 processes the image for installation, an application installation web service may be called upon 526 before proceeding to the application installation tool process 308.

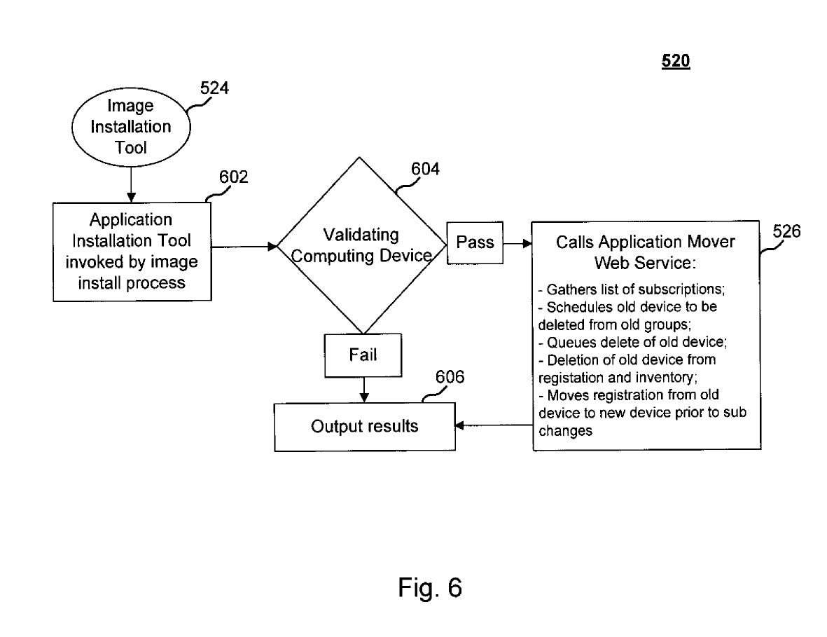

FIG. 6 depicts an illustrative flow for providing an image installation component of the application installation tool 520, according to an exemplary embodiment. In this example, the image installation component 520 may invoke the application installation tool module 200 (e.g., via ISYS) 602 to validate a computing device 604. The validation of the computing device 604 may include checking for any registrations or computing device type. If the validation fails, results may be outputted as an output file 606, such as a text file (e.g., Appinstall_results.txt) or other output file (e.g., XML, HTML, XLS, etc.). In this way, the application installation tool module 200 may know that registration of the computing device may be required.

If the validation passes, meaning there is an image installed on the new computing device, an application installation web service may be provided 524. The application installation web service 524 may comprise: gathering a list of subscriptions in order to put the new computing devices into groups associated with the subscriptions, scheduling the old computing device to be deleted from old groups, queuing deletion of old computing device from registration and inventory, and moving registration from old device prior to subsequent changes. Once these actions are taken, results may be outputted as an output file 606, such as a text file (e.g., Appinstall_results.txt) or other output file (e.g., XML, HTML, XLS, etc.). In this way, the application installation tool module 200 may properly install an image and process associated registrations, etc. before proceeding with application installation, as described above.

Other various embodiments and considerations may also be provided to optimize the application installation tool described above. It should be appreciated that while embodiments are primarily directed to installing applications for new replacement computing device, installation of other items or content to a variety of devices may also be provided. It should also be appreciated that installations using the application installation tool may be configured for operation by one or more customers, analysts, operators, or administrators. In other embodiments, the application installation tool may be entirely automatic or may be a combination of manual and automatic features, some embodiments of which are described above.

While depicted as various servers, components, elements, modules, or devices, it should be appreciated that embodiments may be constructed in software or hardware, as a separate or stand-alone device, or as part of an integrated system, device, or tool.

Additionally, it should also be appreciated that system support and updating the various components of the system or tool may be achieved. For example, a system administrator may have access to one or more of the components of the system, network, components, elements, or device. It should also be appreciated that the one or more servers, components, elements, or devices of the system may not be limited to physical components. These components may be computer-implemented software-based, virtual, etc. Moreover, the various servers, components, elements, or devices may be customized to perform one or more additional features and functionalities. Such features and functionalities may be provided via deployment, transmitting or installing software or hardware.

It should also be appreciated that each of the communications devices, servers, modules, or network elements may include one or more processors. It should be appreciated that one or more data storage systems (e.g., databases) may also be coupled to each of the devices or servers of the system. In one embodiment, the one or more data storage systems may store relevant information for each of the servers and system components. It should also be appreciated that software may be implemented in one or more computer processors, modules, network components, services, devices, or other similar systems.

It should be appreciated that the contents of any of these one or more data storage systems may be combined into fewer or greater numbers of data storage systems and may be stored on one or more data storage systems or servers. Furthermore, the data storage systems may be local, remote, or a combination thereof to client systems, servers, or other system components. In another embodiment, information stored in the databases may be useful in providing additional personalizations and customizations.

By providing an application installation tool according to the above embodiments, a more efficient, accurate, and comprehensive way may be provided for installing applications on a computing device. Improved resource management, streamlined installations, and cost efficiencies may also be achieved.

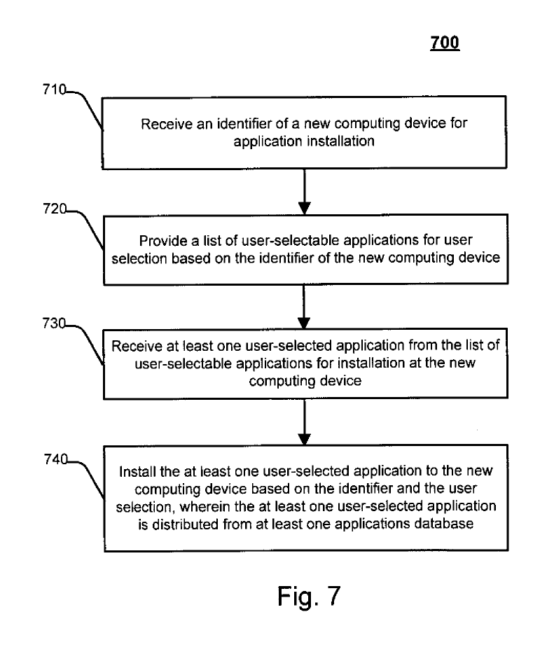

FIG. 7 depicts an illustrative flowchart of a method 700 for using an application installation tool, according to an exemplary embodiment. The exemplary method 700 is provided by way of example, as there are a variety of ways to carry out methods disclosed herein. The method 700 shown in FIG. 13 may be executed or otherwise performed by one or a combination of various systems. The method 700 is described below as carried out by at least system 100 in FIG. 1 and system 200 in FIG. 2, by way of example, and various elements of systems 100 and 200 are referenced in explaining the exemplary method of FIG. 7. Each block shown in FIG. 7 represents one or more processes, methods, or subroutines carried in the exemplary method 700. A computer readable medium comprising code to perform the acts of the method 700 may also be provided. Referring to FIG. 7, the exemplary method 700 may begin at block 710.

At block 710, the input module 202 of FIG. 2 may be configured to receive an identifier of a new computing device. In some embodiments, the input module further configured to receive an identifier of an old computing device, where the list of user-selectable applications may be based at least in part on the applications installed associated with the identifier of the old computing device. In other embodiments, the input module may be further configured to receive a template identifier associated with a user type, where the list of user-selectable applications may be based at least in part on the applications associated with the template identifier.

At block 720, the output module 208 of FIG. 2 may be configured to provide a list of user-selectable applications for user selection based on the identifier of the new computing device.

At block 730, the input module 202 of FIG. 2 may be configured to receive at least one user-selected application from the list of user-selectable applications for installation at the new computing device.

At block 740, the processor module 206 of FIG. 2 may be configured install the at least one user-selected application to the new computing device based on the identifier and the user selection. In this example, the at least one user-selected application may be distributed from at least one applications database communicatively coupled to the processor module.

In embodiments where an identifier of an old computing device is received, the processor may be further configured to remove at least one application from the old computing device corresponding to the at least one user-selected application installed on the new computing device. The processor may be further configured to transfer any licenses associated with the at least one user-selected application from the old computing device to the new computing device. In embodiments where a template identifier is received, the processor may be further configured to apply any licenses associated with the at least one user-selected application to the new computing device.

In some embodiments, the processor may also be configured to install an image to the new computing device based on results of new computing device validation. In this example, the new computing device validation may comprise checking for registration and device type of the new computing device. Other various embodiments may also be provided.

The method 700 may further comprise other various features and functions associated with application installation. For example, in some embodiments, the output module may be configured to provide a list of user-selectable options associated with the list of user-selectable applications for installation at the new computing device, the input module may be configured to receive at least one user-selected option from the list of user-selectable options, and the processor module may be configured to install the at least one user-selected application to the new computing device based on the at least one user-selection option. In some embodiments, the list of the user-selectable options comprises a date option for application installation, a time option for application installation, a sequence option for installing two or more applications, and an automatic scheduling option for processor-determined optimization for application installation. Other various customizable feature associated with application installation ay also be provided.

It should be appreciated that the set of instructions, e.g., the software, that configures the computer operating system to perform the operations described above may be contained on any of a wide variety of media or medium, as desired. Further, any data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by a computer.

In summary, embodiments may provide a system and method for comprehensively and effectively providing an application installation tool. It should be appreciated that although embodiments are described primarily with systems management technologies, the systems and methods discussed above are provided as merely exemplary and may have other various applications and implementations.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

We claim:

1. A system, comprising:
an input module configured to receive an identifier of a new computing device and at least one user-selected application from a list of user-selectable applications for installation at the new computing device;
an output module configured to output at a display device the list of user-selectable applications for user selection based on the identifier of the new computing device; and
a processor module configured to install the at least one user-selected application to the new computing device based on the identifier and the user selection, wherein the processor module is communicatively coupled to at least one applications database from which the at least one user-selected application is distributed.

2. The system of claim 1, wherein the input module further configured to receive an identifier of an old computing device, wherein the list of user-selectable applications is based at least in part on the applications installed associated with the identifier of the old computing device.

3. The system of claim 2, wherein the processor is further configured to remove at least one application from the old computing device corresponding to the at least one user-selected application installed on the new computing device.

4. The system of claim 2, wherein the processor is further configured to transfer any licenses associated with the at least one user-selected application from the old computing device to the new computing device.

5. The system of claim 1, wherein the input module is further configured to receive a template identifier associated with a user type, wherein the list of user-selectable applications is based at least in part on the applications associated with the template identifier.

6. The system of claim 7, wherein the processor is further configured to apply any licenses associated with the at least one user-selected application to the new computing device.

7. The system of claim 1, wherein:
the output module is further configured to provide a list of user-selectable options associated with the list of user-selectable applications for installation at the new computing device;
the input module is further configured to receive at least one user-selected option from the list of user-selectable options; and
the processor module is further configured to install the at least one user-selected application to the new computing device based on the at least one user-selection option.

8. The system of claim 7, wherein the list of the user-selectable options comprises a date option for application installation, a time option for application installation, a sequence option for installing two or more applications, and an automatic scheduling option for processor-determined optimization for application installation.

9. The system of claim 1, wherein the processor is further configured to install an image to the new computing device based on results of new computing device validation.

10. The system of claim 9, wherein the new computing device validation comprises checking for registration and device type of the new computing device.

11. A method, comprising:
receiving, at an input module, an identifier of a new computing device;
providing, by an output module, a list of user-selectable applications for user selection based on the identifier of the new computing device
receiving, at the input module, at least one user-selected application from the list of user-selectable applications for installation at the new computing device;
installing, by a processor module, the at least one user-selected application to the new computing device based on the identifier and the user selection, wherein the at least one user-selected application is distributed from at least one applications database communicatively coupled to the processor module.

12. The method of claim 11, further comprising receiving, at the input module, an identifier of an old computing device, wherein the list of user-selectable applications is based at least in part on the applications installed associated with the identifier of the old computing device.

13. The method of claim 12, further comprising removing, by the processor, at least one application from the old computing device corresponding to the at least one user-selected application installed on the new computing device.

14. The method of claim 12, further comprising transferring, by the processor, any licenses associated with the at least one user-selected application from the old computing device to the new computing device.

15. The method of claim 11, further comprising receiving, at the input module, a template identifier associated with a user type, wherein the list of user-selectable applications is based at least in part on the applications associated with the template identifier.

16. The method of claim 15, applying, by the processor, any licenses associated with the at least one user-selected application to the new computing device.

17. The method of claim 11, further comprising:
providing, by an output module, a list of user-selectable options associated with the list of user-selectable applications for installation at the new computing device;
receiving, at the input module, at least one user-selected option from the list of user-selectable options;
installing, by the processor, the at least one user-selected application to the new computing device based on the at least one user-selection option.

18. The method of claim 17, wherein the list of the user-selectable options comprises a date option for application installation, a time option for application installation, a sequence option for installing two or more applications, and an automatic scheduling option for processor-determined optimization for application installation.

19. The method of claim 11, further comprising installing, by the processor, an image to the new computing device based on results of new computing device validation.

20. The method of claim 19, wherein the new computing device validation comprises checking for registration and device type of the new computing device.

21. A computer readable medium comprising code which when executed causes a computer to perform the method of claim 11.
